(19) United States
(12) Patent Application Publication
(10) Pub. No.: US 2026/0346448 A1
(43) Pub. Date: Nov. 5, 2026

(54) HUMANOID-NATIVE PREDICTIVE ACTUATION VALIDATION USING WHOLE-BODY RUNTIME STATE

(71) Applicant: Dorian Cartwright, San Jose, CA (US)

(72) Inventor: Dorian Cartwright, San Jose, CA (US)

(21) Appl. No.: 19/741,790

(22) Filed: Jul. 14, 2026

Related U.S. Application Data
(63) Continuation-in-part of application No. 19/638,074, filed on Apr. 2, 2026.

(51) Int. Cl. B25J 9/16; G05D 1/495; G05D 109/12

(52) U.S. Cl. CPC B25J 9/1671; B25J 9/1666; G05D 1/495; G05D 2109/12

(57) ABSTRACT

A humanoid robot intercepts a candidate humanoid action before actuator-command dispatch and obtains whole-body runtime state including body configuration and a support, contact, environment, object, human-relative, or actuator state. A predictive actuation validator predicts future physical consequences of executing the candidate action over an action-dependent prediction horizon and evaluates the consequences against humanoid-native criteria including stability, support contact, self-collision, human clearance, actuator limits, terrain contact, or object retention. The validator may dynamically select or configure a forward-looking evaluator according to participating body regions, support phase, contact schedule, payload, uncertainty, or risk. More than one evaluator type may predict different consequence classes for a common action. A release decision releases, modifies, stages, decomposes, reroutes, or rejects the action. Motion of one body region may be validated based on a predicted consequence at another body region, enabling whole-body, cross-region predictive evaluation before physical execution.

### CROSS-REFERENCE TO RELATED APPLICATIONS

The present application is a continuation-in-part of U.S. patent application Ser. No. 19/638,074, filed Apr. 2, 2026, by Dorian Cartwright and entitled PREDICTIVE ACTUATION GATING IN PHYSICAL ARTIFICIAL INTELLIGENCE, the entire contents of which are incorporated herein by reference.

### FIELD OF THE INVENTION

The present disclosure relates generally to computers and artificial intelligence, and more specifically, to intercepting candidate humanoid actions before actuator execution, predicting whole-body physical consequences of the candidate humanoid actions using humanoid runtime state, and selectively releasing, modifying, staging, rerouting, or rejecting the candidate humanoid actions based on the predicted physical consequences.

### BACKGROUND

Humanoid robots increasingly use vision-language-action models, robot foundation models, learned policies, motion planners, behavior trees, reinforcement-learning policies, diffusion policies, teleoperation interpreters, and other decision models to generate physical actions. A humanoid action may involve locomotion, manipulation, gaze, communication, balance recovery, tool use, object handoff, or coordinated movement of multiple articulated body regions.

A humanoid robot differs from many conventional robotic platforms because motion of one body region can materially alter the physical feasibility and safety of another body region. Extending an arm changes whole-body mass distribution. Carrying an object changes foot loading and ground-reaction forces. Rotating a torso changes reachable workspace and angular momentum. A step changes the support state available for manipulation. A head or upper-body movement can affect balance during a narrow-support or recovery phase. Accordingly, an action that appears locally feasible at a hand, arm, leg, or foot may produce an unsafe or infeasible whole-body consequence.

Conventional motion limits, emergency stops, collision monitors, control barrier functions, and low-level controller constraints can provide useful protections. However, such mechanisms may evaluate only a current command or continuous state-space limit and may not predict the coupled physical consequences of a particular AI-generated candidate action over an action-dependent prediction horizon before physical execution begins.

General-purpose guardrails and policy filters may determine whether an action is permitted under a rule, user instruction, mission constraint, or other policy. Such authorization decisions are useful, but behavioral authorization does not necessarily establish that the authorized action will preserve balance, maintain planned support contacts, avoid self-collision, retain a payload, preserve a human-clearance margin, or remain feasible under current terrain, actuator, and body-state conditions.

A further challenge arises because different humanoid actions require different predictive treatment. A low-speed arm movement while the humanoid robot is seated may require a different prediction horizon, body model, contact model, and computation budget than carrying a heavy object up stairs during a single-support gait phase near a human. Running every available high-fidelity evaluator for every candidate action may waste compute and increase latency, while using only a lightweight check may fail to capture high-consequence dynamics.

Existing systems also do not adequately represent a candidate humanoid action as a coordinated machine-interpretable object that identifies participating body regions, expected support contacts, intended object contacts, temporal dependencies, releasable stages, and predicted force or momentum transfer. Without such a representation, a validation layer may fail to determine that a proposed motion of a first body region changes the physical state or permissible action envelope of a second body region.

Accordingly, there is a need for a robust, humanoid-native predictive actuation validation architecture that receives a candidate humanoid action before actuator execution, obtains whole-body runtime state, selects or configures one or more forward-looking evaluators according to the candidate action and runtime state, predicts physical consequences of the candidate action, and generates an action-specific release decision before actuator commands are dispatched.

### SUMMARY

The present disclosure provides systems, methods, and non-transitory computer-readable media for humanoid-native predictive actuation validation using whole-body runtime state.

In one embodiment, a humanoid robot includes an artificial intelligence decision model, a predictive actuation validator, an actuator control interface, and a plurality of actuators associated with articulated body regions. The predictive actuation validator is logically positioned between the decision model and the actuator control interface so that a candidate humanoid action is evaluated before corresponding actuator commands are released for physical execution.

The candidate humanoid action may comprise a machine-interpretable action manifest identifying one or more participating body regions, one or more body-region trajectories, an expected support-contact sequence, an intended object-contact sequence, one or more temporal dependencies, one or more physical execution parameters, a prediction horizon, and action metadata. The candidate humanoid action may represent a locomotion segment, manipulation primitive, whole-body behavior, balance-recovery action, posture transition, bimanual action, handoff action, head or gaze action, tool-use action, or a coordinated combination thereof.

The predictive actuation validator obtains humanoid runtime state. The humanoid runtime state may include a current or predicted support phase, center of mass, center of pressure, support region, capture point, zero-moment point, body configuration, joint state, torso orientation, linear momentum, angular momentum, foot-contact state, hand-contact state, payload state, object state, human-relative state, terrain state, actuator state, battery state, thermal state, or combinations thereof.

The predictive actuation validator uses at least one forward-looking evaluator to predict one or more physical consequences of executing the candidate humanoid action over a prediction horizon. The evaluator may include a learned humanoid world model, learned whole-body dynamics model, physics simulator, digital twin, balance predictor, support-transition predictor, contact predictor, terrain-interaction predictor, self-collision predictor, human-motion predictor, force predictor, grasp-retention predictor, actuator-demand predictor, power or thermal predictor, or rule-based physical-constraint engine.

In some embodiments, the predictive actuation validator dynamically selects a type of forward-looking evaluator based on the candidate humanoid action and humanoid runtime state. Selection factors may include participating body region, action type, gait phase, support phase, predicted contact schedule, payload, speed, terrain class, human proximity, model uncertainty, actuator condition, available compute, latency deadline, or risk classification.

In some embodiments, a single selected forward-looking evaluator is dynamically configured for the candidate humanoid action. Configurable parameters may include prediction horizon, temporal resolution, simulation fidelity, body-model resolution, body-region scope, contact model, terrain model, human-motion model, uncertainty margin, number of simulated samples, validation frequency, compute resource, and acceptance threshold.

In some embodiments, more than one type of forward-looking evaluator is applied to a candidate humanoid action. The evaluators may execute serially, in parallel, hierarchically, or conditionally and may predict different classes of physical consequences. Outputs may be combined using weighted scoring, confidence fusion, priority rules, veto logic, consensus, worst-case selection, or arbitration.

The predictive actuation validator determines whether the predicted physical consequences satisfy one or more humanoid-native validation criteria. The validation criteria may include whole-body stability, preservation of a support margin, feasibility of a support transition, foothold feasibility, slip margin, self-collision avoidance, obstacle clearance, human clearance, joint or actuator limits, force or torque limits, object retention, object fragility, payload stability, energy availability, thermal headroom, or cross-body compatibility.

In some embodiments, motion of a first body region is evaluated based on a predicted consequence at a second body region. For example, an arm extension may be validated based on a predicted center-of-mass shift relative to a foot support region, a payload acceleration may be validated based on predicted foot loading, a torso rotation may be validated based on predicted manipulation workspace and support margin, or a foot placement may be validated based on a predicted effect on a concurrent hand trajectory.

Based on the predicted physical consequences, the predictive actuation validator generates a release decision. The release decision may release the candidate humanoid action, modify the candidate humanoid action, delay or stage a portion of the action, decompose the action into incrementally validated sub-actions, reroute the action to a fallback controller or conservative operating mode, require additional sensing or human approval, or reject the action.

A modification may include changing a foothold, shortening a step, widening a stance, lowering a pelvis or center of mass, altering torso counter-rotation, reallocating motion between limbs, reducing payload acceleration, reducing grasp force, adding a hand support, delaying manipulation until a double-support phase, changing a grasp location, converting simultaneous locomotion and manipulation into staged execution, or entering a kneeling, seated, braced, or controlled-retraction posture.

In some embodiments, the release decision defines a conditional or partial release. A first portion of a candidate humanoid action may be released for a limited time, distance, control-cycle count, body-region set, joint-space region, task-space region, contact state, or support phase. The release may be revalidated, modified, or revoked during execution responsive to updated sensor data or a change in humanoid runtime state.

The predictive actuation validator may provide a release decision, predicted-consequence record, or modified candidate humanoid action to a downstream motion controller, safety runtime, operating-system service, actuator firewall, or other execution component. The downstream component is not required to perform the forward-looking prediction described herein, and predictive actuation validation may operate independently of any separate authorization or dispatch-enforcement architecture.

Validation results, predicted consequences, real-world outcomes, support-margin measurements, slip events, near-falls, recovery events, actuator loads, object-retention outcomes, and human-clearance outcomes may be logged and used to update evaluator-selection policy, evaluator configuration, validation thresholds, humanoid world models, motion-planning models, or action-generation models.

Many other variations are possible.

### BRIEF DESCRIPTION OF THE DRAWINGS

FIG. 1 is a block diagram illustrating a humanoid-native predictive actuation validation system positioned between one or more decision models and an actuator control interface of a humanoid robot, according to an embodiment.

FIG. 2 is a more detailed block diagram illustrating a predictive actuation validator including an action-manifest interface, humanoid-state interface, evaluator-selection and configuration engine, forward-looking evaluation engine, consequence-fusion engine, validation engine, and release-decision engine, according to an embodiment.

FIG. 3 is a sequence or state diagram illustrating interception of a candidate humanoid action, acquisition of whole-body runtime state, forward prediction of physical consequences, generation of a release decision, staged execution, revalidation, and optional revocation, according to an embodiment.

FIG. 4 is a block diagram illustrating a computing environment for implementing the systems and methods described herein, according to an embodiment.

FIG. 5 is a flow chart illustrating an overall method for predictive actuation validation of a humanoid robot, according to an embodiment.

FIG. 6 is a flow chart illustrating dynamic selection and configuration of a forward-looking evaluator based on a candidate humanoid action and humanoid runtime state, according to an embodiment.

FIG. 7 is a flow chart illustrating multi-validator evaluation and cross-body consequence analysis for a candidate humanoid action, according to an embodiment.

FIG. 8 is a flow chart illustrating staged release, runtime revalidation, action modification, and revocation of a candidate humanoid action, according to an embodiment.

### DETAILED DESCRIPTION

The following description provides systems, methods, and computer program products for predictive actuation validation of humanoid robots. The described embodiments are illustrative and not limiting. Features described with respect to one embodiment may be combined with features of other embodiments unless context indicates otherwise.

The disclosed architecture treats an AI-generated physical action as a candidate for execution rather than as an immediately executable actuator command. The architecture predicts what is likely to occur if the candidate humanoid action is carried out and uses the predicted physical consequences to govern release before physical execution begins.

I. Systems

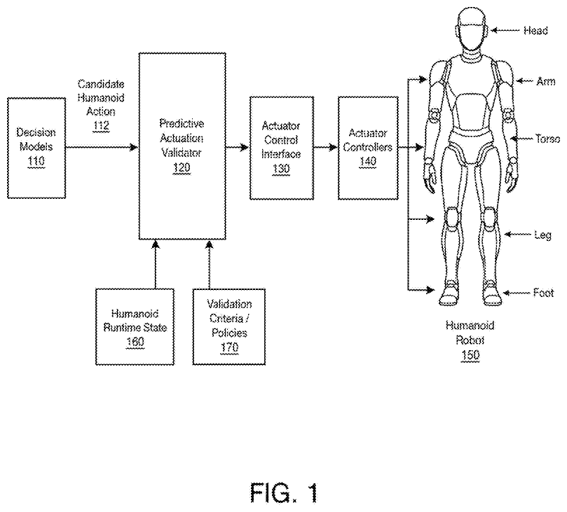

### A. Overall Humanoid Predictive Actuation Validation Architecture (FIG. 1)

FIG. 1 illustrates a humanoid predictive actuation validation system 100. The system 100 includes one or more decision models 110, a predictive actuation validator 120, an actuator control interface 130, actuator controllers 140, actuators 150, and a humanoid runtime-state service 160.

The one or more decision models 110 may include a vision-language-action model, robot foundation model, learned policy, diffusion policy, reinforcement-learning policy, motion planner, whole-body planner, locomotion planner, manipulation planner, behavior tree, task planner, teleoperation interpreter, autonomous agent, language-guided planner, or another computational component that generates or contributes to a candidate humanoid action 112.

The candidate humanoid action 112 may be represented at a behavior level, skill level, task-space level, joint-space level, actuator level, or a combination thereof. For example, the candidate humanoid action 112 may specify walking toward an object, stepping onto a stair, changing support feet, rotating a torso, reaching with an arm, orienting a head, grasping an object, lifting a payload, handing the object to a human or another robot, speaking, or executing a coordinated combination of such operations.

The predictive actuation validator 120 is logically positioned between the one or more decision models 110 and the actuator control interface 130. In some embodiments, the predictive actuation validator 120 is also physically positioned on a communication path between the decision models 110 and the actuator control interface 130. The validator 120 may execute within a humanoid operating system, middleware layer, safety runtime, real-time service, driver boundary, motion-control service, container sidecar, dedicated processor, secure enclave, or distributed combination thereof.

The actuator control interface 130 receives a released or modified humanoid action 122 and translates the released or modified humanoid action 122 into one or more actuator commands. The actuator control interface 130 may include a motion controller, whole-body controller, gait controller, manipulation controller, motor-command broker, robot middleware service, driver framework, or other component that causes actuator controllers 140 to drive actuators 150.

The actuators 150 may be associated with a head, neck, gaze mechanism, torso, shoulder, arm, elbow, wrist, hand, finger, pelvis, hip, leg, knee, ankle, foot, locomotion base, tool interface, facial mechanism, voice-output mechanism, or other humanoid body region. The actuators 150 may include electric motors, servos, brakes, hydraulic actuators, pneumatic actuators, series-elastic actuators, linear actuators, rotary actuators, variable-stiffness actuators, or combinations thereof.

The humanoid runtime-state service 160 provides current, estimated, predicted, or historical state used by the predictive actuation validator 120. The runtime-state service 160 may aggregate data from sensors, state estimators, world models, digital twins, motion planners, body-resource managers, actuator controllers, semantic maps, human-tracking systems, object-tracking systems, and other state sources.

In some embodiments, a release decision, predicted-consequence record, or modified candidate humanoid action generated by the predictive actuation validator 120 is consumed by a downstream controller, safety runtime, operating-system service, actuator firewall, or other execution component. Such a downstream component may apply separate execution, policy, or hardware-control functions without performing the forward-looking physical prediction described herein.

The predictive actuation validator 120 is not limited to a binary allow-or-deny output. It may generate an action modification, staged release, fallback-controller selection, conservative operating mode, request for new sensing, request for replanning, request for human assistance, or another action-governance result. Particular high-fidelity evaluators may be selectively omitted for low-risk actions, while the candidate humanoid action remains subject to predictive actuation validation before release.

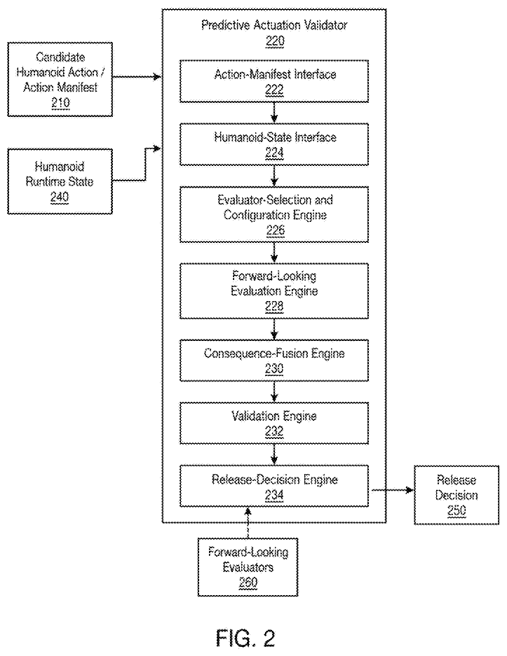

### B. Candidate Humanoid Action Manifest and Whole-Body Runtime State (FIGS. 1-2)

In some embodiments, the candidate humanoid action 112 is normalized into a humanoid action manifest 210. The humanoid action manifest 210 provides a common representation across different decision models, robot vendors, body configurations, and native command formats.

The humanoid action manifest 210 may include an action identifier, source-model identifier, model version, confidence score, task identifier, mission identifier, action type, action horizon, participating body-region identifiers, body-region trajectories, joint targets, task-space targets, desired forces, desired torques, velocities, accelerations, timing relationships, dependencies, release stages, and one or more semantic action labels. Additionally, the humanoid action manifest 210 could include body-region priority, execution dependencies, synchronization points, and expected force-transfer graph. Different body regions may be predictively evaluated at different validation frequencies, such as feet, balance, hands, gaze, and torso.

The humanoid action manifest 210 may further identify an expected support-contact sequence, intended object contacts, expected human interactions, a contact schedule, a predicted payload, a predicted swept volume, an intended support transition, a planned grasp, a planned foothold, a planned handhold, a planned gaze direction, an expected body-region coupling, or a predicted transfer of force or momentum among body regions.

A body-region dependency may identify that execution by a first body region depends on a physical state or action of a second body region. For example, a manipulation portion may depend on entry into double support, a torso rotation may depend on a foot-contact transition, a hand force may depend on a predicted pelvis displacement, or a head movement may depend on a balance margin during recovery from an external disturbance.

The humanoid action manifest 210 may identify releasable stages. A candidate humanoid action may be partitioned into a preparation stage, support-establishment stage, locomotion stage, approach stage, contact stage, force-application stage, payload-transfer stage, withdrawal stage, recovery stage, or other stages. A stage may be released only after validation of prior stages or after a required runtime state is observed.

The humanoid runtime-state service 160 may provide a whole-body state vector 220. The whole-body state vector 220 may include joint positions, joint velocities, joint accelerations, joint torques, actuator currents, actuator temperatures, actuator health, battery state, body pose, pelvis pose, torso orientation, end-effector poses, hand state, foot state, sensor state, and body-region availability.

The whole-body state vector 220 may further include one or more balance and support variables, including center of mass, projected center of mass, center of pressure, support polygon or support region, capture point, zero-moment point, centroidal momentum, linear momentum, angular momentum, single-support state, double-support state, no-support state, hand-supported state, kneeling state, seated state, climbing state, suspended state, or a transitional support state.

The runtime-state service 160 may provide an environment and interaction state 230. The environment and interaction state 230 may include terrain classification, terrain geometry, friction estimate, compliance estimate, foothold region, obstacle state, self-collision geometry, human position, human motion, human-proximity zone, object identity, object pose, object mass, object fragility, object compliance, object ownership, tool state, shared-object state, peer-robot state, and semantic hazard state.

The runtime-state service 160 may provide uncertainty and freshness information. A state item may be associated with a confidence score, covariance, age, source identity, update rate, predicted validity interval, or failure state. The predictive actuation validator 120 may increase safety margins, select a higher-fidelity evaluator, reduce the permitted action envelope, request new sensing, or reject an action when relevant state is uncertain or stale.

The runtime state may be shared with a humanoid-native VLA model, humanoid world model, whole-body motion planner, locomotion planner, manipulation planner, body-resource manager, predictive validator, actuator firewall, and other runtime components. Shared access may reduce redundant state reconstruction and permit a predictor to evaluate a candidate action using the same body and world state used to generate the action. In another embodiment, shared runtime memory can be used by the humanoid0native VLA, humanoid world model, whole-body planner, and locomotion planner, instead of reconstructing state.

### C. Predictive Actuation Validator, Dynamic Selection, AND Configuration (FIG. 2)

FIG. 2 illustrates an example predictive actuation validator 120 including an action-manifest interface 310, humanoid-state interface 320, evaluator-selection and configuration engine 330, one or more forward-looking evaluators 340, consequence-fusion engine 350, validation engine 360, release-decision engine 370, and validation log 380.

The action-manifest interface 310 receives or generates the humanoid action manifest 210. The humanoid-state interface 320 receives the whole-body state vector 220 and environment and interaction state 230. In some embodiments, the interfaces 310, 320 maintain temporal alignment between the candidate humanoid action and the runtime state used for prediction.

The evaluator-selection and configuration engine 330 determines how the candidate humanoid action is to be predictively evaluated. The engine 330 may select a single evaluator, multiple evaluators, an evaluator sequence, an evaluator hierarchy, a fallback evaluator, or an evaluator ensemble. The engine 330 may also configure a selected evaluator rather than selecting among different evaluator implementations.

Selection factors may include an action type, participating body region, support phase, predicted contact schedule, speed, acceleration, payload, moment arm, terrain class, object fragility, human proximity, self-collision risk, model uncertainty, sensor uncertainty, actuator health, available compute, power state, thermal headroom, network state, latency deadline, operating mode, prior validation history, or risk classification.

For example, a low-speed arm motion while the humanoid robot is seated and remote from humans may be evaluated using a reduced body model and a short-horizon kinematic predictor. A step during single support may be evaluated using a higher-resolution whole-body dynamics model. Carrying a heavy object up stairs near a human may cause selection of a full-body dynamics simulator, terrain-contact model, human-motion predictor, and grasp-retention predictor.

The evaluator-selection and configuration engine 330 may configure a prediction horizon based on action duration, speed, uncertainty, contact timing, support phase, human proximity, payload, or risk. A reflex-scale horizon may cover milliseconds. A joint-control horizon may cover several control cycles. A gait horizon may cover one or more support transitions. A manipulation horizon may cover approach, contact, force application, and withdrawal. A task horizon may cover a multi-step coordinated behavior.

The engine 330 may configure temporal resolution separately from prediction horizon. A long prediction horizon may use coarse resolution for distant portions and finer resolution near contact, support transition, human proximity, or expected instability. In some embodiments, adaptive refinement is applied around predicted risk events.

The engine 330 may configure simulation fidelity, body-model resolution, contact model, terrain model, human-motion model, uncertainty margin, sample count, validation threshold, and compute resource. A lightweight evaluator may execute on a microcontroller, CPU, or dedicated safety core. A higher-fidelity evaluator may execute on a GPU, NPU, physics accelerator, edge server, or cloud resource, provided that latency and communication conditions satisfy release requirements. In some embodiments, the evaluator-selection engine predicts an expected prediction complexity prior to selecting or configuring the evaluator.

The one or more forward-looking evaluators 340 predict one or more physical consequences that would result from executing the candidate humanoid action. The evaluators 340 may operate using deterministic simulation, probabilistic simulation, learned prediction, sampling, optimization, formal constraints, symbolic rules, hybrid models, or combinations thereof.

A learned humanoid world model may predict future body, object, and environment states. A learned whole-body dynamics model may predict joint, contact, force, momentum, and balance trajectories. A physics simulator or digital twin may simulate body and environment interactions. A balance predictor may estimate support margin, capture-point behavior, or fall likelihood. A support-transition predictor may estimate acquisition or loss of foot, hand, knee, or other support contacts.

A contact predictor may predict hand, foot, tool, object, or human contact. A terrain-interaction predictor may estimate slip, penetration, compliance, or support failure. A self-collision predictor may estimate collision among body regions or attached tools. A human-motion predictor may estimate future human occupancy and separation. A grasp-retention predictor may estimate slip, object rotation, force distribution, or loss of retention. An actuator-demand predictor may estimate torque, power, temperature, or saturation.

When multiple evaluators 340 are used, the evaluators may predict different consequence classes. For example, a first evaluator may predict whole-body stability, a second evaluator may predict self-collision, and a third evaluator may predict grasp retention. The consequence-fusion engine 350 may combine evaluator outputs using weighted scoring, confidence fusion, priority rules, veto logic, consensus, worst-case selection, Bayesian combination, learned arbitration, or another fusion process.

The consequence-fusion engine 350 may preserve evaluator-specific outputs rather than reducing all outputs to a single score. This enables the validation engine 360 to apply different criteria to different consequence classes and to generate a modification directed to the particular cause of a validation failure.

The validation engine 360 determines whether the predicted physical consequences satisfy one or more validation criteria. Criteria may be fixed, dynamically selected, dynamically configured, user-defined, manufacturer-defined, learned, task-specific, body-region-specific, support-phase-specific, environment-specific, or combinations thereof.

A whole-body stability criterion may require a projected center of mass, capture point, zero-moment point, or other balance variable to remain within a support-dependent region or margin. A contact criterion may require acquisition, retention, or release of one or more planned contacts. A self-collision criterion may require minimum separation among body regions. A human-clearance criterion may require a predicted swept volume to remain outside a human-separation envelope.

A cross-body criterion may evaluate motion of a first body region based on a consequence at a second body region. In one example, an arm extension is denied or modified because the predicted center-of-mass shift would reduce a foot support margin below a threshold. In another example, a foot placement is modified because the predicted torso compensation would place an end effector too close to a human. In another example, a payload acceleration is reduced because predicted ankle torque or sole pressure exceeds a threshold.

The validation engine 360 may evaluate a candidate action using deterministic limits, risk scores, probability thresholds, confidence intervals, worst-case bounds, reachable sets, safety margins, utility functions, task-completion constraints, or combinations thereof. Different criteria may be applied at different stages of a candidate humanoid action.

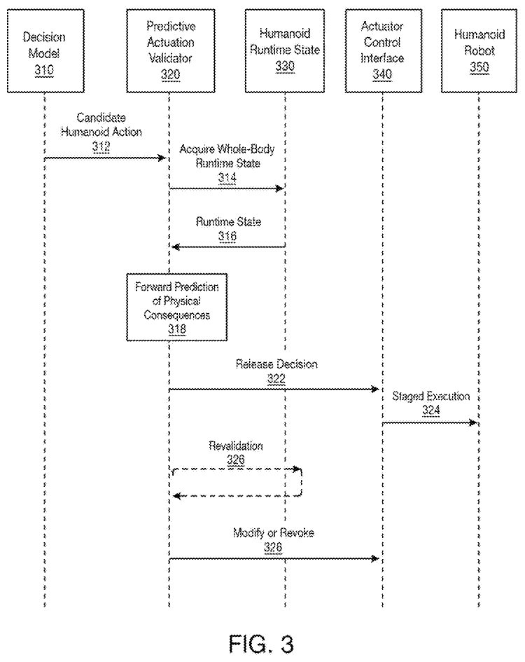

### D. Release Decisions, Action Modification, Staging, and Runtime Revalidation (FIG. 3)

The release-decision engine 370 generates a release decision based on the predicted physical consequences and validation results. The release decision may release the candidate humanoid action as proposed, release a modified action, release only a stage or body-region subset, delay execution, request additional sensing, request replanning, reroute to a fallback controller, require human assistance, or reject execution.

An action modification may be generated by applying an optimization process subject to predicted physical constraints. The modification may change one or more body-region trajectories while preserving a task objective. For example, a reach action may be modified by widening stance, lowering pelvis height, reducing reach speed, adding torso counter-rotation, changing the reaching arm, using a support hand, or moving the base before reaching.

A locomotion action may be modified by changing a foothold, shortening a step, widening a stance, reducing speed, changing gait, delaying an upper-body motion, reducing payload acceleration, or selecting an alternate terrain path. A manipulation action may be modified by changing a grasp point, reducing grip force, altering wrist orientation, changing approach direction, adding a second hand, or delaying contact until a more stable support phase.

In some embodiments, the release-decision engine 370 converts a simultaneous whole-body action into a staged action. For example, a candidate action specifying stepping while reaching may be changed into a first stage that establishes double support, a second stage that executes the reach, and a third stage that resumes locomotion. The modified sequence may preserve the task objective while reducing predicted balance risk.

A fallback controller may include a conservative gait controller, static-pose controller, brace controller, controlled-retraction controller, kneeling controller, seated controller, compliant-contact controller, teleoperation controller, reflex controller, or another controller configured to reduce risk. Selection of a fallback controller may be based on the predicted consequence that caused validation failure.

The release decision may define conditional release parameters. The conditional release parameters may identify permitted body regions, joints, trajectories, workspace regions, contact states, forces, torques, velocities, accelerations, timing relationships, support phases, object contacts, human-clearance margins, validity periods, revalidation triggers, or revocation conditions derived from the predicted physical consequences.

FIG. 3 illustrates an example state sequence. In a candidate state, the decision model proposes a candidate humanoid action. In an evaluation state, the predictive actuation validator predicts physical consequences. In a released state, at least a portion of the action is provided to the actuator control interface. In an execution-monitoring state, updated runtime state is compared with the state assumed during prediction. In a revalidation state, remaining action stages are re-evaluated. In a modified, fallback, or revoked state, execution is changed responsive to a material state deviation.

Revalidation may occur at a gait boundary, support transition, contact event, object-motion event, human-proximity event, elapsed-time interval, control-cycle count, distance threshold, confidence change, actuator-state change, policy change, or another trigger. Revalidation may use the same evaluator, a differently configured evaluator, or a newly selected evaluator.

A release may be revoked when a foot loses contact, terrain classification changes, an object moves, a human enters a predicted swept volume, actuator temperature exceeds a threshold, payload estimate changes, a model uncertainty increases, or another condition invalidates the predicted consequence analysis. Revocation may stop a body region, hold a safe posture, transition to a fallback controller, or cause controlled withdrawal.

The validation log 380 may store the action manifest, runtime state, selected evaluator, evaluator configuration, predicted consequences, validation criteria, release decision, modifications, execution telemetry, and real-world outcomes. In some embodiments, personally identifiable or sensitive sensor data is omitted, redacted, hashed, or retained by reference.

Logged outcomes may be used to adapt evaluator-selection policy, prediction horizons, fidelity selection, validation thresholds, gait templates, terrain models, grasp models, human-clearance margins, action-generation models, or whole-body planners. Near-falls, foot-slip events, successful recoveries, payload oscillation, object-retention failures, and other humanoid-native outcomes may provide training or calibration signals.

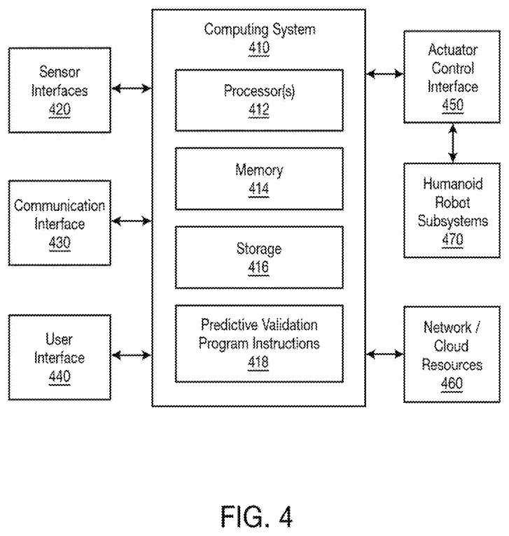

### E. Computing Environment (FIG. 4)

FIG. 4 illustrates an example computing environment 400 including one or more processors 410, memory 420, storage 430, input/output interfaces 440, communication interfaces 450, sensor interfaces 460, actuator interfaces 470, and one or more buses 490.

The processors 410 may include central processing units, graphics processing units, tensor processing units, neural processing units, digital signal processors, physics accelerators, field-programmable gate arrays, application-specific integrated circuits, microcontrollers, real-time controllers, secure processors, or combinations thereof.

The predictive actuation validator may execute on a single processor or across multiple processors. In one embodiment, a lightweight kinematic or rule-based evaluator executes on a real-time controller while a learned world model executes on an NPU and a high-fidelity physics simulator executes on a GPU. Evaluator outputs may be synchronized according to action deadlines and confidence requirements.

The memory 420 may store a humanoid operating system, decision models, action manifests, humanoid runtime state, evaluator models, body models, terrain models, human-motion models, validation criteria, release decisions, execution envelopes, validation logs, and computer-executable instructions for performing the disclosed functions.

The storage 430 may include nonvolatile memory, solid-state storage, persistent memory, removable storage, network storage, or combinations thereof. The input/output interfaces 440 may support user interfaces, displays, microphones, speakers, teleoperation devices, maintenance interfaces, or development tools. The communication interfaces 450 may support wired, wireless, local, edge, cloud, robot-to-robot, or infrastructure communication.

The sensor interfaces 460 may receive data from cameras, depth sensors, lidar, radar, inertial measurement units, joint encoders, force-torque sensors, tactile sensors, pressure sensors, sole sensors, microphones, proximity sensors, thermal sensors, current sensors, battery sensors, or combinations thereof. The actuator interfaces 470 may communicate with body-region controllers, motor drivers, brake controllers, tool controllers, or other actuator endpoints.

The disclosed functions may be implemented in software, firmware, hardware, microcode, programmable logic, operating-system services, middleware modules, real-time control loops, drivers, secure enclaves, hypervisors, dedicated processors, distributed services, or combinations thereof.

### II. Methods

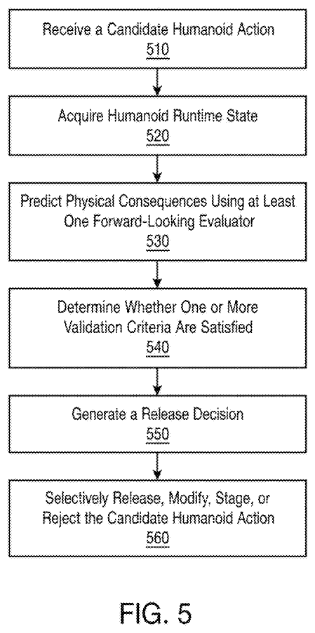

A. Overall Humanoid Predictive Actuation Validation Method (FIG. 5)

FIG. 5 illustrates a method 500 for predictive actuation validation of a humanoid robot.

At step 510, a candidate humanoid action generated by one or more decision models is intercepted before corresponding actuator commands are released for physical execution.

At step 520, a humanoid action manifest and humanoid runtime state associated with the candidate humanoid action are obtained.

At step 530, one or more physical consequences of executing the candidate humanoid action are predicted over an action-dependent prediction horizon using at least one forward-looking evaluator.

At step 540, the predicted physical consequences are evaluated against one or more humanoid-native validation criteria.

At step 550, a release decision is generated to release, modify, stage, decompose, reroute, or reject the candidate humanoid action.

At step 560, a released or modified portion of the candidate humanoid action is provided to an actuator control interface for execution subject to any release conditions or revalidation triggers.

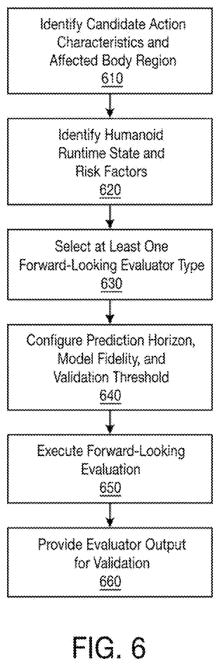

### B. Dynamic Evaluator Selection and Configuration Method (FIG. 6)

FIG. 6 illustrates a method 600 for dynamic selection and configuration of one or more forward-looking evaluators.

At step 610, action parameters and participating body regions are identified from the candidate humanoid action.

At step 620, a current or predicted support phase, contact schedule, payload state, human-relative state, uncertainty state, and available compute state are determined.

At step 630, a type of forward-looking evaluator is dynamically selected based on the action parameters and humanoid runtime state.

At step 640, at least one of a prediction horizon, temporal resolution, simulation fidelity, body-region scope, contact model, terrain model, uncertainty margin, sample count, validation frequency, or acceptance threshold is configured for the selected evaluator.

At step 650, the selected and configured evaluator is executed to predict physical consequences of the candidate humanoid action before actuator release.

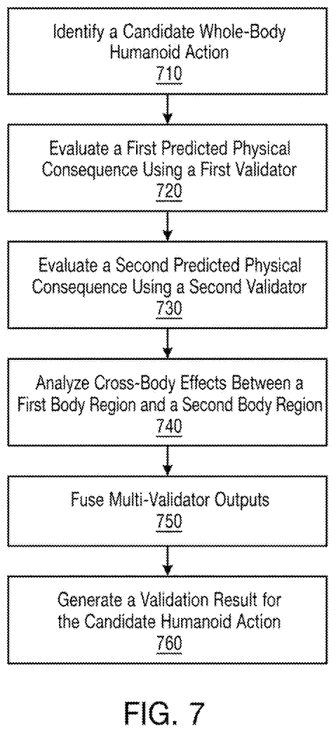

### C. Multi-Validator and Cross-Body Consequence Analysis Method (FIG. 7)

FIG. 7 illustrates a method 700 for evaluating a candidate humanoid action using multiple types of forward-looking evaluators and cross-body consequence analysis.

At step 710, two or more consequence classes associated with the candidate humanoid action are identified, including at least one of stability, support transition, self-collision, human clearance, contact, grasp retention, actuator demand, power, or thermal consequence.

At step 720, at least two different types of forward-looking evaluators are selected to predict different respective consequence classes.

At step 730, outputs of the at least two different evaluator types are combined or arbitrated while preserving an association between each output and its consequence class.

At step 740, motion of a first humanoid body region is evaluated based on a predicted physical consequence at a second humanoid body region or support contact.

At step 750, a release decision or action modification is generated based on the combined evaluator outputs and cross-body consequence analysis.

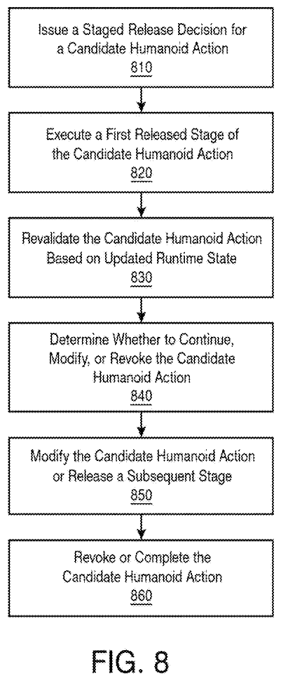

### D. Staged Release, Revalidation, and Revocation Method (FIG. 8)

FIG. 8 illustrates a method 800 for staged release and runtime revalidation of a candidate humanoid action.

At step 810, the candidate humanoid action is decomposed into a plurality of temporally ordered or state-dependent stages.

At step 820, a first stage is released subject to a release envelope and one or more revalidation triggers.

At step 830, updated humanoid runtime state and execution telemetry are obtained during or after execution of the first stage.

At step 840, a remaining stage is revalidated using the updated humanoid runtime state, and the remaining stage is released, modified, delayed, rerouted, or rejected.

At step 850, an outstanding release is revoked or a fallback controller is engaged responsive to a material deviation from a predicted support, contact, balance, human-clearance, object, or actuator state.

### III. Generalities

As used herein, a humanoid robot includes a physically embodied artificial intelligence platform having an articulated morphology that includes at least a torso and one or more articulated upper-body or lower-body regions. A humanoid robot may be bipedal, wheeled-humanoid, partially humanoid, full-body humanoid, stationary humanoid, mobile manipulator having humanoid body regions, or another platform having human-like articulated body organization.

As used herein, a candidate humanoid action includes any proposed physical behavior generated by or on behalf of a decision model that can cause physical actuation by a humanoid robot. A candidate humanoid action may include natural-language instructions, skills, action tokens, trajectories, poses, joint commands, force commands, contact plans, gait primitives, manipulation primitives, whole-body motions, body-region commands, or combinations thereof.

As used herein, predictive actuation validation includes evaluating a candidate humanoid action before at least a corresponding portion of the candidate humanoid action is physically executed by predicting one or more physical consequences that would result from execution. Predictive actuation validation is distinct from merely observing a physical outcome after execution has begun, although predictive validation may continue iteratively during staged execution.

As used herein, a forward-looking evaluator includes a learned model, simulator, predictor, digital twin, deterministic model, probabilistic model, symbolic engine, rule-based engine, formal constraint process, optimization process, or hybrid process configured to predict or estimate a future physical consequence of executing a candidate humanoid action.

As used herein, a validator type may be distinguished by model architecture, predicted consequence class, body-region scope, fidelity, prediction method, computation resource, temporal horizon, input state, or other technical characteristic. More than one type of validator for an action does not require physically separate devices or separately named software modules.

As used herein, humanoid runtime state includes current, historical, estimated, predicted, or derived data describing the humanoid robot, its environment, an object, a person, a peer robot, a mission, or an actuator condition relevant to predicting physical consequences of a candidate humanoid action.

As used herein, a support phase includes a current or predicted state describing physical support of a humanoid robot, including single-foot support, double-foot support, hand support, knee support, seated support, climbing support, no support, suspended state, transitional support, or a combination of support contacts.

As used herein, a release decision includes a machine-readable result that governs whether or how a candidate humanoid action proceeds toward physical execution. A release decision may comprise approval, modification, partial approval, staged approval, delay, decomposition, rerouting, fallback-controller selection, human-approval request, sensing request, replanning request, rejection, revocation, or combinations thereof.

Although certain embodiments describe predictive validation before an actuator control interface, the predictive actuation validator may be positioned at different locations within a humanoid stack, including at a model-output boundary, planner boundary, skill boundary, operating-system boundary, middleware boundary, driver boundary, actuator-controller boundary, or distributed across multiple boundaries.

Although certain embodiments describe one predictive actuation validator, the validator may comprise multiple cooperating components, processes, models, devices, or services. Conversely, functions described as separate interfaces, engines, evaluators, or modules may be integrated into a single component or model.

Although certain embodiments describe dynamic selection among evaluators, a single evaluator may be dynamically configured for different candidate actions. Conversely, multiple evaluators may be applied without dynamic selection. The disclosed embodiments support single-evaluator, multi-evaluator, selected-evaluator, configured-evaluator, serial, parallel, hierarchical, and ensemble arrangements.

Predictive actuation validation does not require generation of a cryptographic token, state-bound actuator-dispatch authorization, or mandatory trust boundary. The predictive actuation validator may directly supply a released or modified action to an actuator control interface or may provide predictive outputs to another execution, policy, or enforcement component.

Features described in connection with systems may be implemented as methods or non-transitory computer-readable media, and features described in connection with methods may be implemented as systems or computer-readable media. Steps may be reordered, repeated, omitted, performed concurrently, or divided among local, edge, cloud, and actuator-proximate computing resources unless a particular order is expressly required.

The singular forms “a,” “an,” and “the” include plural references unless context clearly indicates otherwise. The terms “comprising,” “including,” and “having” are open-ended. The term “or” is inclusive unless expressly stated otherwise. Numerical examples and named metrics are illustrative and do not limit the scope of the disclosure.

What is claimed is:

1. A computer-implemented method for predictive actuation validation of a humanoid robot, comprising:
intercepting, by a predictive actuation validator before issuance of actuator commands, a candidate humanoid action generated by one or more decision models, the candidate humanoid action comprising a machine-interpretable representation of proposed coordinated physical behavior of one or more articulated body regions of the humanoid robot;
obtaining humanoid runtime state associated with the candidate humanoid action, the humanoid runtime state comprising a body configuration and at least one of a support state, a contact state, an environment state, an object state, a human-relative state, or an actuator state;
predicting, by the predictive actuation validator using at least one forward-looking evaluator, one or more future physical consequences of executing the candidate humanoid action over an action-dependent prediction horizon selected or configured based at least in part on the candidate humanoid action or the humanoid runtime state;
determining, based on the one or more predicted future physical consequences, whether the candidate humanoid action satisfies one or more humanoid-native validation criteria comprising at least one of a whole-body stability criterion, a support-contact criterion, a self-collision criterion, a human-clearance criterion, an actuator-limit criterion, a force criterion, a terrain-contact criterion, or an object-retention criterion; and
generating, based on the determining, a release decision that causes the candidate humanoid action to be released for execution, modified before execution, staged for partial execution, decomposed for incremental validation, rerouted to a fallback controller or conservative operating mode, or rejected from execution.

2. The computer-implemented method of claim 1, further comprising dynamically selecting a type of the at least one forward-looking evaluator based on at least an identified body region participating in the candidate humanoid action, a current or predicted support phase, and a risk parameter associated with the candidate humanoid action.

3. The computer-implemented method of claim 1, wherein predicting the one or more physical consequences comprises evaluating the candidate humanoid action using at least two different types of forward-looking evaluators configured to predict different respective classes of physical consequences.

4. The computer-implemented method of claim 3, wherein outputs of the at least two different types of forward-looking evaluators are combined using at least one of weighted scoring, confidence fusion, a priority rule, veto logic, consensus, worst-case selection, or arbitration.

5. The computer-implemented method of claim 1, wherein the candidate humanoid action includes motion of a first body region, and wherein determining whether the candidate humanoid action satisfies the one or more humanoid-native validation criteria comprises evaluating a predicted effect of the motion on a support state, balance state, collision state, contact state, or actuator demand of a second body region.

6. The computer-implemented method of claim 1, further comprising dynamically configuring at least one of the prediction horizon, a temporal resolution, a simulation fidelity, a body-region scope, a contact model, a terrain model, an uncertainty margin, a sample count, a validation frequency, or an acceptance threshold of the at least one forward-looking evaluator based on the candidate humanoid action and the humanoid runtime state.

7. The computer-implemented method of claim 1, wherein the candidate humanoid action comprises a manipulation portion and a locomotion portion, and wherein the release decision delays the manipulation portion until the humanoid robot transitions from a first support phase to a second support phase.

8. The computer-implemented method of claim 1, wherein modifying the candidate humanoid action comprises at least one of changing a foothold, shortening a step, widening a stance, lowering a center of mass, altering torso counter-rotation, reallocating motion between limbs, reducing payload acceleration, adding a support contact, reducing grasp force, or changing an order of locomotion and manipulation.

9. The computer-implemented method of claim 1, further comprising obtaining updated humanoid runtime state during execution of a released portion of the candidate humanoid action and revalidating or revoking a remaining portion responsive to a change in the updated humanoid runtime state.

10. The computer-implemented method of claim 1, wherein rerouting the candidate humanoid action comprises selecting at least one of a conservative gait controller, static-pose controller, brace controller, controlled-retraction controller, kneeling controller, seated controller, compliant-contact controller, teleoperation controller, or reflex controller.

11. A humanoid robotic system comprising:
a humanoid body comprising a torso, at least one articulated upper-body region, at least one articulated lower-body region, a plurality of actuators, and one or more actuator controllers;
one or more decision models configured to generate a candidate humanoid action comprising proposed coordinated physical behavior of one or more body regions;
a humanoid runtime-state interface configured to provide a body configuration and at least one of a support state, contact state, environment state, object state, human-relative state, or actuator state;
a predictive actuation validator logically positioned between the one or more decision models and an actuator control interface, the predictive actuation validator configured to:
predict, using at least one forward-looking evaluator, one or more future physical consequences of executing the candidate humanoid action over an action-dependent prediction horizon, the one or more physical consequences including a predicted future state of at least one body region, support contact, object, or human-relative spatial condition;
evaluate the one or more future physical consequences against one or more humanoid-native validation criteria; and
generate a release decision governing whether and how the candidate humanoid action is provided to the actuator control interface before corresponding actuator commands are issued to the one or more actuator controllers.

12. The humanoid robotic system of claim 11, wherein the candidate humanoid action is represented by a humanoid action manifest comprising identifiers of participating body regions, a temporal relationship among body-region trajectories, an expected support-contact sequence, and one or more releasable stages.

13. The humanoid robotic system of claim 11, wherein the humanoid runtime-state interface provides shared runtime state used by at least a humanoid-native vision-language-action model, a humanoid world model, a whole-body motion planner, and the predictive actuation validator.

14. The humanoid robotic system of claim 11, wherein the predictive actuation validator is configured to dynamically select a first evaluator for a first candidate humanoid action and a different evaluator or differently configured evaluator for a second candidate humanoid action based on respective body-region participation, support phase, contact schedule, or risk classification.

15. The humanoid robotic system of claim 11, wherein the predictive actuation validator is configured to temporally align the candidate humanoid action with the humanoid runtime state used by the at least one forward-looking evaluator such that the predicted physical consequences correspond to a common action-state reference time.

16. The humanoid robotic system of claim 11, wherein the release decision defines conditional release parameters identifying at least one of permitted body regions, permitted joints, permitted trajectories, a permitted workspace, a permitted contact state, a force or torque limit, a support-phase condition, a validity period, a revalidation trigger, or a revocation condition.

17. The humanoid robotic system of claim 11, wherein the predictive actuation validator is configured to identify a predicted physical consequence that fails a humanoid-native validation criterion and generate an action modification that changes at least one body-region trajectory selected based on the identified predicted physical consequence while preserving a task objective of the candidate humanoid action.

18. A non-transitory computer-readable medium storing instructions that, when executed by one or more processors of a humanoid robot, cause the one or more processors to:
receive, before actuator-command dispatch, a candidate humanoid action generated by one or more decision models;
obtain humanoid runtime state comprising a body configuration and a current or predicted support state;
configure a predictive actuation validator for the candidate humanoid action based on the humanoid runtime state;
predict one or more future physical consequences of executing the candidate humanoid action;
evaluate the one or more future physical consequences against one or more humanoid-native validation criteria; and
generate a release decision governing physical execution of the candidate humanoid action.

19. The non-transitory computer-readable medium of claim 18, wherein the instructions further cause the one or more processors to select and execute at least two different types of predictive validators for the candidate humanoid action, the at least two different types predicting different respective physical consequence classes.

20. The non-transitory computer-readable medium of claim 18, wherein the instructions further cause the one or more processors to evaluate motion of a first articulated body region based on a predicted change in a support margin, center-of-mass state, contact state, collision state, or actuator demand associated with a second articulated body region.
